(19) United States
(12) Patent Application Publication
(10) Pub. No.: US 2025/0327713 A1
(43) Pub. Date: Oct. 23, 2025

(54) ELECTRIC VEHICLE BATTERY LEAK DETECTOR

(71) Applicant: Midtronics, Inc., Willowbrook, IL (US)

(72) Inventor: Kevin I. Bertness, Batavia, IL (US)

(21) Appl. No.: 19/181,596

(22) Filed: Apr. 17, 2025

Related U.S. Application Data
(60) Provisional application No. 63/635,801, filed on Apr. 18, 2024.

(51) Int. Cl. G01M 3/26; B60L 3/00; B60L 58/16; G01M 3/20; G07C 5/08; H01M 10/42

(52) U.S. Cl. CPC G01M 3/26; B60L 3/0046; G01M 3/20; G07C 5/0808; H01M 10/4228; H01M 10/4285; B60L 58/16; H01M 2220/20

(57) ABSTRACT

An electric vehicle battery test vessel, includes a first housing portion configured to securely receive a battery of an electric vehicle, wherein the battery in contained in a sealed battery casing. A second housing portion is arranged to seal the storage battery in the first housing portion, and selectively open whereby the battery can be removed from or placed into the first housing portion. A sealing mechanism is configured to seal the first housing portion to the second housing portion;. A differential pressure source is arranged to create a pressure differential between an external pressure on an exterior of the battery casing and an internal pressure on an interior of the storage battery casing. A pressure sensor measures at least one of the external and internal pressures and monitors for pressure changes indicative of a leak in the battery casing.

### CROSS-REFERENCE TO RELATED APPLICATION

The present application is based on and claims the benefit of U.S. provisional patent application Ser. No. 63/635,801, filed Apr. 18, 2024, the content of which is hereby incorporated by reference in its entirety.

### BACKGROUND OF THE INVENTION

The present invention relates to electric vehicles of the types which use battery packs for storing electricity. More specifically, the present invention relates to maintenance of such battery packs.

Traditionally, automotive vehicles have used internal combustion engines as their power source. Petroleum as a source of power. However, vehicles which also store energy in batteries are finding widespread use. Such vehicle can provide increased fuel efficiency and can be operated using alternative energy sources.

Some types of electric vehicles are completely powered using electric motors and electricity. Other types of electric vehicles include an internal combustion engine. The internal combustion engine can be used to generate electricity and supplement the power delivered by the electric motor. These types of vehicles are known as “hybrid” electric vehicles.

Operation of an electric vehicle requires a source of electricity. Typically, electric vehicles store electricity in large battery packs which consist of a plurality of batteries. These batteries may be formed by a number of individual cells or may themselves be individual cells depending on the configuration of the battery and battery pack. The packs are typically large and replacement can be expensive.

Electric vehicle batteries and component modules are typically sizable and contain substantial stored electro-chemical energy with lethal voltages present. These two conditions result in significant fire and electrocution potential.

If the casing of a battery is damaged, or a seal fails, contaminants can enter the battery and result in degradation and eventual failure of the battery. Further, if such a condition occurs, gas from within the battery casing can escape.

### SUMMARY OF THE INVENTION

An electric vehicle battery test vessel, includes a first housing portion configured to securely receive a battery of an electric vehicle, wherein the battery in contained in a sealed battery casing. A second housing portion is arranged to seal the storage battery in the first housing portion, and selectively open whereby the battery can be removed from or placed into the first housing portion. A sealing mechanism is configured to seal the first housing portion to the second housing portion;. A differential pressure source is arranged to create a pressure differential between an external pressure on an exterior of the battery casing and an internal pressure on an interior of the storage battery casing. A pressure sensor measures at least one of the external and internal pressures and monitors for pressure changes indicative of a leak in the battery casing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified block diagram of an electric vehicle.

FIG. 2 is simplified schematic diagram of a battery pack for use in the electric vehicle of FIG. 1.

FIG. 3 is a block diagram of an electric vehicle battery storage vessel in accordance with one example embodiment of the present invention.

FIG. 4 illustrates a database shown in FIG. 3.

FIG. 5 is a simplified block diagram showing an electric vehicle battery storage vessel including a cradle configured to receive battery.

FIG. 6 shows graphs of voltage and current versus time charging of a battery.

FIG. 7 shows graphs of voltage and current versus discharging of a battery.

FIG. 8 is a perspective view of an electric vehicle battery storage vessel in accordance with one example embodiment.

FIG. 9 is a perspective enlarged view of a sealing mechanism used to seal a first portion to a second portion of the electric vehicle battery storage vessel of FIG. 8.

FIG. 10 is a view of a gas sensor associated with the storage vessel of FIG. 8.

FIG. 11 is a view of an interior portion of the storage vessel of FIG. 8 showing a shock absorbing footing.

FIG. 12 is a view of the sealing mechanism in an open position.

FIG. 13 is a view of an interior portion of the storage vessel including an integral listing apparatus.

FIG. 14 is a top view of the storage vessel of FIG. 8 showing a track used for nested stacking of a plurality of storage vessels.

FIG. 15 is an enlarged view of feet associated with the storage vessel of FIG. 8 which are configured to be received by the groove shown in FIG. 14.

FIG. 16 shows safety markings associated with the storage vessel of FIG. 8.

FIG. 17 illustrates a document pouch caried on the storage vessel of FIG. 8.

FIG. 18 illustrates an integrated fire suppression system for use on an interior of the storage vessel of FIG. 8.

FIG. 19 shows a connector plug for electrical coupling to circuitry of the storage vessel of FIG. 8 and/or a battery contained in the storage vessel of FIG. 8.

FIG. 20 illustrates stacked storage vessels.

FIG. 21 shows a display carried on the storage vessel of FIG. 8 for communicating with an operator.

FIG. 22 illustrates a gas sensor associate with the storage vessel of FIG. 8.

FIG. 23 illustrates a shock or motion sensor carried on the storage vessel of FIG. 8.

FIG. 24 illustrates a DC to DC converter for use in powering circuitry of the storage vessel of FIG. 8.

FIG. 25 shows a geo tag associated with the storage vessel of FIG. 8.

FIG. 26 shows a warning light for providing a visible output from the storage vessel of FIG. 8.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

As discussed in the background section, battery packs used with electric vehicles are able to store large amounts of energy. The battery packs are large and difficult to work on and test because of the high voltages involved. Further, the battery packs are expensive. After removing a storage battery from an electric vehicle, the battery may need to be transported to another location. The transportation process should ensure safety of both the transporting vehicle as well as the battery. Further, it is important to ensure that the battery is maintained during transportation. Further still, it is important that a casing of the battery pack, and/or batteries within the pack, are sealed and do not leak.

In one aspect of the present invention, a battery pack is removed from the electric vehicle whereby maintenance can be performed on it. In many instances, the maintenance needs to be performed at a different location and the storage battery must be transported to that location. In one aspect, the present invention provides an electric vehicle battery storage vessel which can receive different configurations of storage batteries, secure the storage battery and/or provide maintenance to the storage battery while the battery is in the vessel.

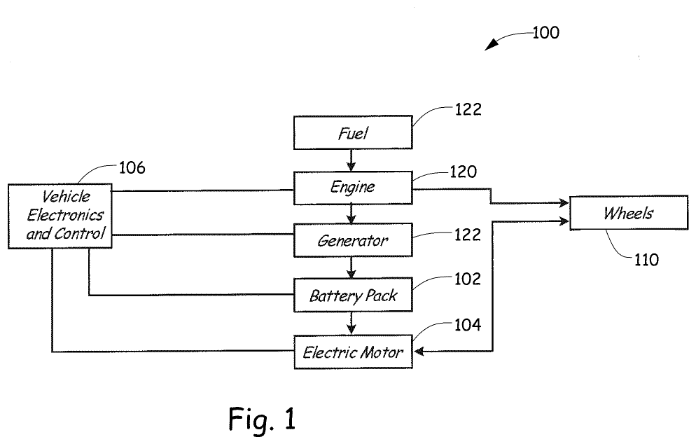

FIG. 1 is a simplified block diagram of an electric vehicle 100. Electric vehicle 100 can be configured to operate solely based upon electric power, or may include an internal combustion engine. Vehicle 100 includes a battery pack 102 and at least one electric motor 104. Vehicle electronics and control system 106 couples to the battery pack and electric motor and is configured to control their operation. Wheels 110 of vehicle 100 are configured to propel the vehicle in response to a mechanical input from electric motor 104. Electric motor 104 operates using energy drawn from the battery 102. In some configurations a regenerative braking system can be used in which a braking energy is recovered from the wheels 110 by the electric motor 104 or other equipment. The recovered energy can be used to recharge the battery pack 102.

FIG. 1 also shows optional components of vehicle 100. These optional components allow the vehicle 100 to operate as “hybrid” vehicle. In such a configuration, an internal combustion engine 120 is provided which operates using, for example, petroleum-based fuel 122. The engine 120 can be configured to directly mechanically drive the wheels 110 and/or an electric generator 122. The electric generator 122 can be configured to charge the battery pack 102 and/or provide electrical power directly to electric motor 104.

The battery pack 102 is a critical component of the electric vehicle 100. Operation of the battery pack 102 will determine the efficiency of the vehicle, the overall range of the vehicle, the rate at which the battery pack 102 can be charged and the rate at which the battery pack 102 can be discharged.

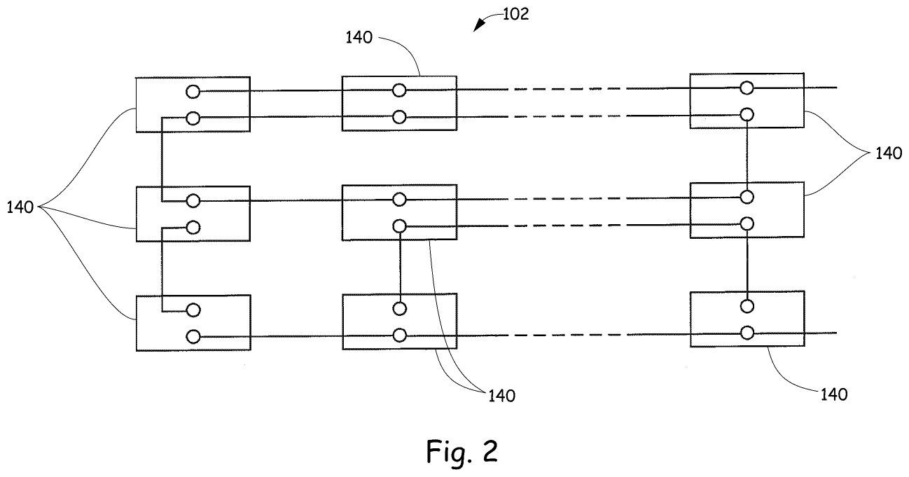

FIG. 2 is a simplified diagram of an example configuration of battery pack 102. In FIG. 2, a plurality of individual batteries 140 are shown connected in series and parallel. Each of the individual batteries 140 may comprise a single cell or may comprise multiple cells connected in series and/or parallel. These may be removable battery modules formed by a single cell or a group of cells. If elements 140 are a group of cells, in some configurations individual connections may be available within the battery and used in accordance with the invention.

During the lifetime of vehicle 100, the battery pack 102 will degrade with time and use. This degradation may be gradual, or may occur rapidly based upon a failure of a component within the pack 102. When such a failure occurs, or when the pack has degraded sufficiently, the entire battery pack 102 is typically replaced. The battery pack 102 is one of the primary components of electric vehicle 100 and its replacement can be very expensive. In one aspect, the present invention is directed to performing maintenance on battery pack 102. The maintenance can be performed after the battery pack has failed, or prior to the failure of the battery pack. The maintenance can include placement in a battery storage vessel for transport to another location

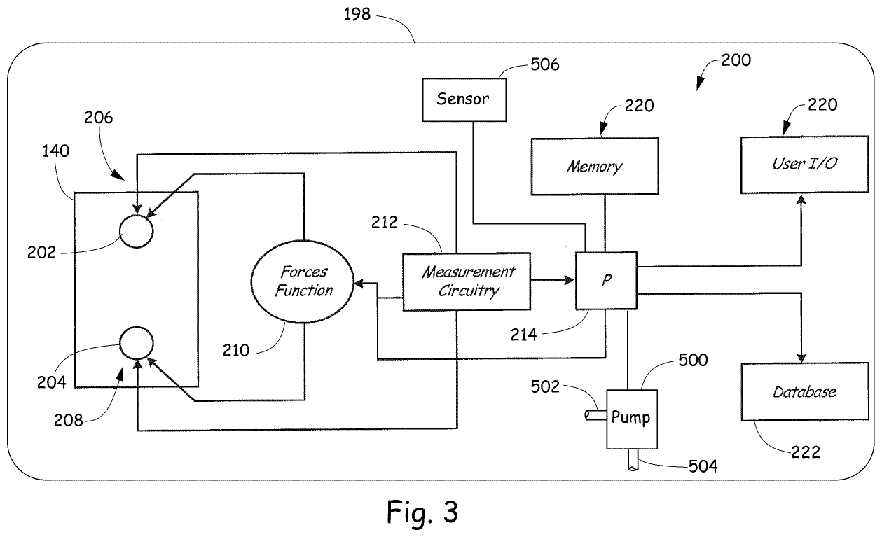

FIG. 3 is a simplified block diagram of a battery pack maintenance device 200 for performing maintenance on battery pack 102 associated with an electric vehicle battery storage vessel 198. FIG. 3 shows one example of battery test circuitry, in FIG. 3 maintenance device 200 is shown coupled to battery 140 having a positive terminal 202 and a negative terminal 204. A connection 206 is provided to terminal 202 and a similar connector 208 is provided to terminal 204. The connectors 204 and 206 are illustrated as Kelvin connectors, however, the invention is not limited to this configuration. Through connections 206 and 208, a forcing function 210 is coupled to battery 140. The forcing function applies a forcing function signal to the battery 140. The forcing function signal may have a time varying component and may be an active signal in which an electrical signal is injected into the battery or maybe a passive signal in which a current is drawn from the battery. Measurement circuitry 212 is configured to measure a response to the battery 140 to the applied forcing function signal from the forcing function 210. Measurement circuitry 212 provides a measurement signal to microprocessor 214. Microprocessor 214 operates in accordance with instructions stored in memory 220. Memory 220 may also be configured to contain parameters measured from battery 140. A user input/output circuitry 220 is provided for use by an operator. Further, the device 200 is configured to store data in database 220. The battery testing may be optionally performed in accordance with techniques pioneered by Midtronics, Inc. of Willowbrook, Illinois, and Dr. Keith S. Champlin, including for example, those discussed in U.S. Pat. No. 3,873,911, issued Mar. 25, 1975, to Champlin; U.S. Pat. No. 3,909,708, issued Sep. 30, 1975, to Champlin; U.S. Pat. No. 4,816,768, issued Mar. 28, 1989, to Champlin; U.S. Pat. No. 4,825,170, issued Apr. 25, 1989, to Champlin; U.S. Pat. No. 4,881,038, issued Nov. 14, 1989, to Champlin; U.S. Pat. No. 4,912,416, issued Mar. 27, 1990, to Champlin; U.S. Pat. No. 5,140,269, issued Aug. 18, 1992, to Champlin; U.S. Pat. No. 5,343,380, issued Aug. 30, 1994; U.S. Pat. No. 5,572,136, issued Nov. 5, 1996; U.S. Pat. No. 5,574,355, issued Nov. 12, 1996; U.S. Pat. No. 5,583,416, issued Dec. 10, 1996; U.S. Pat. No. 5,585,728, issued Dec. 17, 1996; U.S. Pat. No. 5,589,757, issued Dec. 31, 1996; U.S. Pat. No. 5,592,093, issued Jan. 7, 1997; U.S. Pat. No. 5,598,098, issued Jan. 28, 1997; U.S. Pat. No. 5,656,920, issued Aug. 12, 1997; U.S. Pat. No. 5,757,192, issued May 26, 1998; U.S. Pat. No. 5,821,756, issued Oct. 13, 1998; U.S. Pat. No. 5,831,435, issued Nov. 3, 1998; U.S. Pat. No. 5,871,858, issued Feb. 16, 1999; U.S. Pat. No. 5,914,605, issued Jun. 22, 1999; U.S. Pat. No. 5,945,829, issued Aug. 31, 1999; U.S. Pat. No. 6,002,238, issued Dec. 14, 1999; U.S. Pat. No. 6,037,751, issued Mar. 14, 2000; U.S. Pat. No. 6,037,777, issued Mar. 14, 2000; U.S. Pat. No. 6,051,976, issued Apr. 18, 2000; U.S. Pat. No. 6,081,098, issued Jun. 27, 2000; U.S. Pat. No. 6,091,245, issued Jul. 18, 2000; U.S. Pat. No. 6,104,167, issued Aug. 15, 2000; U.S. Pat. No. 6,137,269, issued Oct. 24, 2000; U.S. Pat. No. 6,163,156, issued Dec. 19, 2000; U.S. Pat. No. 6,172,483, issued Jan. 9, 2001; U.S. Pat. No. 6,172,505, issued Jan. 9, 2001; U.S. Pat. No. 6,222,369, issued Apr. 24, 2001; U.S. Pat. No. 6,225,808, issued May 1, 2001; U.S. Pat. No. 6,249,124, issued Jun. 19, 2001; U.S. Pat. No. 6,259,254, issued Jul. 10, 2001; U.S. Pat. No. 6,262,563, issued Jul. 17, 2001; U.S. Pat. No. 6,294,896, issued Sep. 25, 2001; U.S. Pat. No. 6,294,897, issued Sep. 25, 2001; U.S. Pat. No. 6,304,087, issued Oct. 16, 2001; U.S. Pat. No. 6,310,481, issued Oct. 30, 2001; U.S. Pat. No. 6,313,607, issued Nov. 6, 2001; U.S. Pat. No. 6,313,608, issued Nov. 6, 2001; U.S. Pat. No. 6,316,914, issued Nov. 13, 2001; U.S. Pat. No. 6,323,650, issued Nov. 27, 2001; U.S. Pat. No. 6,329,793, issued Dec. 11, 2001; U.S. Pat. No. 6,331,762, issued Dec. 18, 2001; U.S. Pat. No. 6,332,113, issued Dec. 18, 2001; U.S. Pat. No. 6,351,102, issued Feb. 26, 2002; U.S. Pat. No. 6,359,441, issued Mar. 19, 2002; U.S. Pat. No. 6,363,303, issued Mar. 26, 2002; U.S. Pat. No. 6,377,031, issued Apr. 23, 2002; U.S. Pat. No. 6,392,414, issued May 21, 2002; U.S. Pat. No. 6,417,669, issued Jul. 9, 2002; U.S. Pat. No. 6,424,158, issued Jul. 23, 2002; U.S. Pat. No. 6,441,585, issued Aug. 17, 2002; U.S. Pat. No. 6,437,957, issued Aug. 20, 2002; U.S. Pat. No. 6,445,158, issued Sep. 3, 2002; U.S. Pat. No. 6,456,045; U.S. Pat. No. 6,466,025, issued Oct. 15, 2002; U.S. Pat. No. 6,465,908, issued Oct. 15, 2002; U.S. Pat. No. 6,466,026, issued Oct. 15, 2002; U.S. Pat. No. 6,469,511, issued Nov. 22, 2002; U.S. Pat. No. 6,495,990, issued Dec. 17, 2002; U.S. Pat. No. 6,497,209, issued Dec. 24, 2002; U.S. Pat. No. 6,507,196, issued Jan. 14, 2003; U.S. Pat. No. 6,534,993; issued Mar. 18, 2003; U.S. Pat. No. 6,544,078, issued Apr. 8, 2003; U.S. Pat. No. 6,556,019, issued Apr. 29, 2003; U.S. Pat. No. 6,566,883, issued May 20, 2003; U.S. Pat. No. 6,586,941, issued Jul. 1, 2003; U.S. Pat. No. 6,597,150, issued Jul. 22, 2003; U.S. Pat. No. 6,621,272, issued Sep. 16, 2003; U.S. Pat. No. 6,623,314, issued Sep. 23, 2003; U.S. Pat. No. 6,633,165, issued Oct. 14, 2003; U.S. Pat. No. 6,635,974, issued Oct. 21, 2003; U.S. Pat. No. 6,696,819, issued February 24, 20144; U.S. Pat. No. 6,707,303, issued Mar. 16, 2004; U.S. Pat. No. 6,737,831, issued May 18, 2004; U.S. Pat. No. 6,744,149, issued Jun. 1, 2004; U.S. Pat. No. 6,759,849, issued Jul. 6, 2004; U.S. Pat. No. 6,781,382, issued Aug. 24, 2004; U.S. Pat. No. 6,788,025, filed Sep. 7, 2004; U.S. Pat. No. 6,795,782, issued Sep. 21, 2004; U.S. Pat. No. 6,805,090, filed Oct. 19, 2004; U.S. Pat. No. 6,806,716, filed Oct. 19, 2004; U.S. Pat. No. 6,850,037, filed Feb. 1, 2005; U.S. Pat. No. 6,850,037, issued Feb. 1, 2005; U.S. Pat. No. 6,871,151, issued Mar. 22, 2005; U.S. Pat. No. 6,885,195, issued Apr. 26, 2005; U.S. Pat. No. 6,888,468, issued May 3, 2005; U.S. Pat. No. 6,891,378, issued May 10, 2005; U.S. Pat. No. 6,906,522, issued Jun. 14, 2005; U.S. Pat. No. 6,906,523, issued Jun. 14, 2005; U.S. Pat. No. 6,909,287, issued Jun. 21, 2005; U.S. Pat. No. 6,914,413, issued Jul. 5, 2005; U.S. Pat. No. 6,913,483, issued Jul. 5, 2005; U.S. Pat. No. 6,930,485, issued Aug. 16, 2005; U.S. Pat. No. 6,933,727, issued August 23, 200; U.S. Pat. No. 6,941,234, filed Sep. 6, 2005; U.S. Pat. No. 6,967,484, issued Nov. 22, 2005; U.S. Pat. No. 6,998,847, issued Feb. 14, 2006; U.S. Pat. No. 7,003,410, issued Feb. 21, 2006; U.S. Pat. No. 7,003,411, issued Feb. 21, 2006; U.S. Pat. No. 7,012,433, issued Mar. 14, 2006; U.S. Pat. No. 7,015,674, issued Mar. 21, 2006; U.S. Pat. No. 7,034,541, issued Apr. 25, 2006; U.S. Pat. No. 7,039,533, issued May 2, 2006; U.S. Pat. No. 7,058,525, issued Jun. 6, 2006; U.S. Pat. No. 7,081,755, issued Jul. 25, 2006; U.S. Pat. No. 7,106,070, issued Sep. 12, 2006; U.S. Pat. No. 7,116,109, issued Oct. 3, 2006; U.S. Pat. No. 7,119,686, issued Oct. 10, 2006; and U.S. Pat. No. 7,126,341, issued Oct. 24, 2006; U.S. Pat. No. 7,154,276, issued Dec. 26, 2006; U.S. Pat. No. 7,198,510, issued Apr. 3, 2007; U.S. Pat. No. 7,363,175, issued Apr. 22, 2008; U.S. Pat. No. 7,208,914, issued Apr. 24, 2007; U.S. Pat. No. 7,246,015, issued Jul. 17, 2007; U.S. Pat. No. 7,295,936, issued Nov. 13, 2007; U.S. Pat. No. 7,319,304, issued Jan. 15, 2008; U.S. Pat. No. 7,363,175, issued Apr. 22, 2008; U.S. Pat. No. 7,398,176, issued Jul. 8, 2008; U.S. Pat. No. 7,408,358, issued Aug. 5, 2008; U.S. Pat. No. 7,425,833, issued Sep. 16, 2008; U.S. Pat. No. 7,446,536, issued Nov. 4, 2008; U.S. Pat. No. 7,479,763, issued Jan. 20, 2009; U.S. Pat. No. 7,498,767, issued Mar. 3, 2009; U.S. Pat. No. 7,501,795, issued Mar. 10, 2009; U.S. Pat. No. 7,505,856, issued Mar. 17, 2009; U.S. Pat. No. 7,545,146, issued Jun. 9, 2009; U.S. Pat. No. 7,557,586, issued Jul. 7, 2009; U.S. Pat. No. 7,595,643, issued Sep. 29, 2009; U.S. Pat. No. 7,598,699, issued Oct. 6, 2009; U.S. Pat. No. 7,598,744, issued Oct. 6, 2009; U.S. Pat. No. 7,598,743, issued Oct. 6, 2009; U.S. Pat. No. 7,619,417, issued Nov. 17, 2009; U.S. Pat. No. 7,642,786, issued Jan. 5, 2010; U.S. Pat. No. 7,642,787, issued Jan. 5, 2010; U.S. Pat. No. 7,656,162, issued Feb. 2, 2010; U.S. Pat. No. 7,688,074, issued Mar. 30, 2010; U.S. Pat. No. 7,705,602, issued Apr. 27, 2010; U.S. Pat. No. 7,706,992, issued Apr. 27, 2010; U.S. Pat. No. 7,710,119, issued May 4, 2010; U.S. Pat. No. 7,723,993, issued May 25, 2010; U.S. Pat. No. 7,728,597, issued Jun. 1, 2010; U.S. Pat. No. 7,772,850, issued Aug. 10, 2010; U.S. Pat. No. 7,774,151, issued Aug. 10, 2010; U.S. Pat. No. 7,777,612, issued Aug. 17, 2010; U.S. Pat. No. 7,791,348, issued Sep. 7, 2010; U.S. Pat. No. 7,808,375, issued Oct. 5, 2010; U.S. Pat. No. 7,924,015, issued Apr. 12, 2011; U.S. Pat. No. 7,940,053, issued May 10, 2011; U.S. Pat. No. 7,940,052, issued May 10, 2011; U.S. Pat. No. 7,959,476, issued Jun. 14, 2011; U.S. Pat. No. 7,977,914, issued Jul. 12, 2011; U.S. Pat. No. 7,999,505, issued August 16, 2011; U.S. Patent No. D643,759, issued Aug. 23, 2011; U.S. Pat. No. 8,164,343, issued Apr. 24, 2012; U.S. Pat. No. 8,198,900, issued Jun. 12, 2012; U.S. Pat. No. 8,203,345, issued Jun. 19, 2012; U.S. Pat. No. 8,237,448, issued Aug. 7, 2012; U.S. Pat. No. 8,306,690, issued Nov. 6, 2012; U.S. Pat. No. 8,344,685, issued Jan. 1, 2013; U.S. Pat. No. 8,436,619, issued May 7, 2013; U.S. Pat. No. 8,442,877, issued May 14, 2013; U.S. Pat. No. 8,493,022, issued Jul. 23, 2013; U.S. Patent No. D687,727, issued Aug. 13, 2013; U.S. Pat. No. 8,513,949, issued Aug. 20, 2013; U.S. Pat. No. 8,674,654, issued Mar. 18, 2014; U.S. Pat. No. 8,674,711, issued Mar. 18, 2014; U.S. Pat. No. 8,704,483, issued Apr. 22, 2014; U.S. Pat. No. 8,738,309, issued May 27, 2014; U.S. Pat. No. 8,754,653, issued Jun. 17, 2014; U.S. Pat. No. 8,872,516, issued Oct. 28, 2014; U.S. Pat. No. 8,872,517, issued Oct. 28, 2014; U.S. Pat. No. 8,958,998, issued Feb. 17, 2015; U.S. Pat. No. 8,963,550, issued Feb. 24, 2015; U.S. Pat. No. 9,018,958, issued Apr. 28, 2015; U.S. Pat. No. 9,052,366, issued Jun. 9, 2015; U.S. Pat. No. 9,201,120, issued Dec. 1, 2015; U.S. Pat. No. 9,229,062, issued January 5, 20126; U.S. Pat. No. 9,244,100, issued Jan. 26, 2016; U.S. Pat. No. 9,255,955, issued Feb. 9, 2016; U.S. Pat. No. 9,274,157, issued Mar. 1, 2016; U.S. Pat. No. 9,312,575, issued Apr. 12, 2016; U.S. Pat. No. 9,335,362, issued May 10, 2016; U.S. Pat. No. 9,425,487, issued Aug. 23, 2016; U.S. Pat. No. 9,419,311, issued Aug. 16, 2016; U.S. Pat. No. 9,496,720, issued Nov. 15, 2016; U.S. Pat. No. 9,588,185, issued Mar. 7, 2017; U.S. Pat. No. 9,923,289, issued Mar. 20, 2018; U.S. Pat. No. 9,966,676, issued May 8, 2018; U.S. Pat. No. 10,046,649, issued Aug. 14, 2018; U.S. Pat. No. 10,222,397, issued Mar. 5, 2019; U.S. Pat. No. 10,317,468, issued Jun. 11, 2019; U.S. Pat. No. 10,429,449, issued Oct. 1, 2019; U.S. Pat. No. 10,473,555, issued Nov. 12, 2019; U.S. Pat. No. 10,608,353, issued Mar. 31, 2020; U.S. Pat. No. 10,843,574, issued Nov. 24, 2020; U.S. Pat. No. 11,054,480, issued Jul. 6, 2021; U.S. Pat. No. 11,325,479, issued May 10, 2022; U.S. Pat. No. 11,474,153, issued Oct. 18, 2022; U.S. Pat. No. 11,486,930, issued Nov. 1, 2022; U.S. Pat. No. 11,513,160, issued Nov. 29, 2022; U.S. Pat. No. 11,545,839, issued Jan. 3, 2023; U.S. Pat. No. 11,548,404, issued Jan. 10, 2023; U.S. Pat. No. 11,566,972, issued Jan. 31, 2023; U.S. Pat. No. 11,650,259, issued May 16, 2023; U.S. Pat. No. 11,668,779, issued Jun. 6, 2023; U.S. Pat. No. 11,740,294, issued Aug. 29, 2023; U.S. Pat. No. 11,926,224, issued Mar. 12, 2024; U.S. Pat. No. 11,973,202, issued Apr. 30, 2024; U.S. Pat. No. 12,196,813, issued Jan. 14, 2025; U.S. Pat. No. 12,237,482, issued Feb. 25, 2025; U.S. Ser. No. 09/780,146, filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/880,473, filed Jun. 13, 2001; entitled BATTERY TEST MODULE; U.S. Ser. No. 10/109,734, filed Mar. 28, 2002, entitled APPARATUS AND METHOD FOR COUNTERACTING SELF DISCHARGE IN A STORAGE BATTERY; U.S. Ser. No. 10/263,473, filed Oct. 2, 2002, entitled ELECTRONIC BATTERY TESTER WITH RELATIVE TEST OUTPUT; U.S. Ser. No. 09/653,963, filed Sep. 1, 2000, entitled SYSTEM AND METHOD FOR CONTROLLING POWER GENERATION AND STORAGE; U.S. Ser. No. 10/174,110, filed Jun. 18, 2002, entitled DAYTIME RUNNING LIGHT CONTROL USING AN INTELLIGENT POWER MANAGEMENT SYSTEM; U.S. Ser. No. 10/258,441, filed Apr. 9, 2003, entitled CURRENT MEASURING CIRCUIT SUITED FOR BATTERIES; U.S. Ser. No. 10/681,666, filed Oct. 8, 2003, entitled ELECTRONIC BATTERY TESTER WITH PROBE LIGHT; U.S. Ser. No. 11/207,419, filed Aug. 19, 2005, entitled SYSTEM FOR AUTOMATICALLY GATHERING BATTERY INFORMATION FOR USE DURING BATTERY TESTER/CHARGING, U.S. Ser. No. 11/356,443, filed Feb. 16, 2006, entitled ELECTRONIC BATTERY TESTER WITH NETWORK COMMUNICATION; U.S. Ser. No. 12/697,485, filed Feb. 1, 2010, entitled ELECTRONIC BATTERY TESTER; U.S. Ser. No. 12/769,911, filed Apr. 29, 2010, entitled STATIONARY BATTERY TESTER; U.S. Ser. No. 13/152,711, filed Jun. 3, 2011, entitled BATTERY PACK MAINTENANCE FOR ELECTRIC VEHICLE; U.S. Ser. No. 14/039,746, filed Sep. 27, 2013, entitled BATTERY PACK MAINTENANCE FOR ELECTRIC VEHICLE; U.S. Ser. No. 14/565,589, filed Dec. 10, 2014, entitled BATTERY TESTER AND BATTERY REGISTRATION TOOL; U.S. Ser. No. 15/017,887, filed Feb. 8, 2016, entitled METHOD AND APPARATUS FOR MEASURING A PARAMETER OF A VEHICLE ELECTRICAL SYSTEM; U.S. Ser. No. 15/049,483, filed Feb. 22, 2016, entitled BATTERY TESTER FOR ELECTRIC VEHICLE; U.S. Ser. No. 15/077,975, filed Mar. 23, 2016, entitled BATTERY MAINTENANCE SYSTEM; U.S. Ser. No. 15/149,579, filed May 9, 2016, entitled BATTERY TESTER FOR ELECTRIC VEHICLE; U.S. Ser. No. 16/253,526, filed Jan. 22, 2019, entitled HIGH CAPACITY BATTERY BALANCER; U.S. Ser. No. 17/364,953, filed Jul. 1, 2021, entitled ELECTRICAL LOAD FOR ELECTRONIC BATTERY TESTER AND ELECTRONIC BATTERY TESTER INCLUDING SUCH ELECTRICAL LOAD; U.S. Ser. No. 17/504,897, filed Oct. 19, 2021, entitled HIGH CAPACITY BATTERY BALANCER; U.S. Ser. No. 17/750,719, filed May 23, 2022, entitled BATTERY MONITORING SYSTEM; U.S. Ser. No. 17/893,412, filed Aug. 23, 2022, entitled POWER ADAPTER FOR AUTOMOTIVE VEHICLE MAINTENANCE DEVICE; U.S. Ser. No. 18/166,702, filed Feb. 9, 2023, entitled BATTERY MAINTENANCE DEVICE WITH HIGH VOLTAGE CONNECTOR; U.S. Ser. No. 18/314,266, filed May 9, 2023, entitled ELECTRONIC BATTERY TESTER, U.S. Ser. No. 18/324,382, filed May 26, 2023, entitled STACKABLE BATTERY MAINTENANCE SYSTEM, U.S. Ser. No. 18/328,827, filed Jun. 5, 2023, entitled ELECTRIC VEHICLE BATTERY STORAGE VESSEL; U.S. Ser. No. 18/616,458, filed Mar. 26, 2024, entitled EV BATTERY CHARGING SOLUTION FOR CONTAINERS; U.S. Ser. No. 18/740,030, filed Jun. 11, 2024 U.S. Ser. No. 18/914,573, filed Oct. 14, 2024, entitled ELECTRIC VEHICLE MAINTENANCE DEVICE; U.S. Ser. No. 18/930,713, filed Oct. 29, 2024, entitled VEHICLE MAINTENANCE SYSTEM WITH DYNAMIC NETWORK; U.S. Ser. No. 19/048,167, filed Feb. 7, 2025, entitled ELECTRIC VEHICLE MAINTENANCE DEVICE; all of which are incorporated herein by reference in their entireties.

During operation, device 200 is capable of measuring a parameter of battery 140 through the Kelvin connections 206 and 208. For example, a forcing function can be applied by forcing function 210. Measurement circuitry 212 can monitor the effect of the applied forcing function signal on the battery 140 and responsively provide an output to microprocessor 214. This can be used to measure a dynamic parameter of the battery such as dynamic conductance, etc. The present invention is not limited to this particular testing method and other techniques may also be employed. Further, the testing of battery 140 or group of batteries 140 may be performed using sensors within battery pack 102. In such a configuration, the testing may be performed without disassembling the battery pack 102. Microprocessor 214 can operate in accordance with programming instructions stored in memory 220. Memory 220 can also store information by microprocessor 214. Operation of device 200 can be controlled by user I/O 220 which can comprise, for example, a manual input such as a keyboard and/or an output such as a display. As discussed below in greater detail, measured parameters of battery can be stored in database 222 for subsequent retrieval.

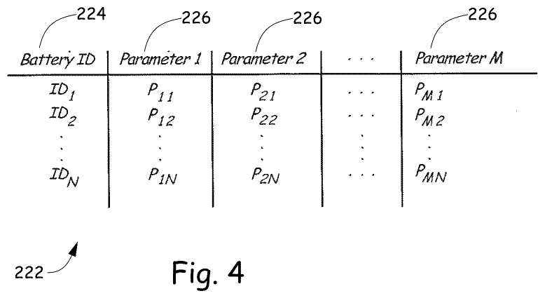

FIG. 4 shows an example configuration of database 222. Database 222 includes a number of different fields. A battery identification field 224 is used to store information which identifies a battery 140. The battery 140 may be a battery from within an existing battery pack 102 or may be a new battery 140. At least one battery parameter 226 is associated with an identified battery which is collected by maintenance device 200. In some configurations, more than one battery parameter 226 is associated with one specific battery 140.

The battery identification 224 can be in accordance with any technique which will provide information which can be used to identify a battery. This may include, for example, a serial number or the like. The identifying information can be created during the refurbishing process, or at some other time, for example, during manufacture of a battery 140 or pack 102. This information may be manually entered into the database 222 using, for example, user I/O 220 shown in FIG. 3 or may be entered into database 222 using more automated techniques such as a barcode scanner, RFID tag, etc. User I/O 220 may comprise such inputs. The battery parameter 226 can comprise any information which is related to an identified battery 140. The information can be information obtained through a battery test or may be information obtained through other means. For example, information related to the age of the battery may be used, information related to whether the battery 140 came from a battery pack 102 in which an operator has or has not identified any problems, manufacturing information, geographic location information, information related to a location of a battery within the battery pack 102, etc. Examples of other parameters include parameters collected by testing the battery may include temperature, etc. The temperature may be, for example, a temperature profile obtained during transportation or otherwise while the battery is contained in the storage vessel 198. These parameters may include the results of any type of battery test or data measured or collected prior to, during, or after a test is performed and are not limited to those discussed herein.

During operation of the system discussed above, any bad battery packs 102 are identified by testing. This may require that the battery pack 102 be charged and discharged. Further, battery pack 102 may be charged or discharged while on vessel 198.

Industrial batteries may be tested while remaining in the pack through connections at individual points between multiple batteries. In another example, the entire battery pack 102 may be tested by supplying a known current to the entire pack 102, or a portion of the pack 102. This current may be a DC current, a time varying DC current, a bi-polar current, a uni-polar AC current, etc. While is current is applied, a battery 140 or groups of batteries 140 within the battery pack 102 or the entire pack can be monitored. This monitoring may be through sensors which are internal to the battery pack 102 or through sensors which are separably applied to the battery pack 102.

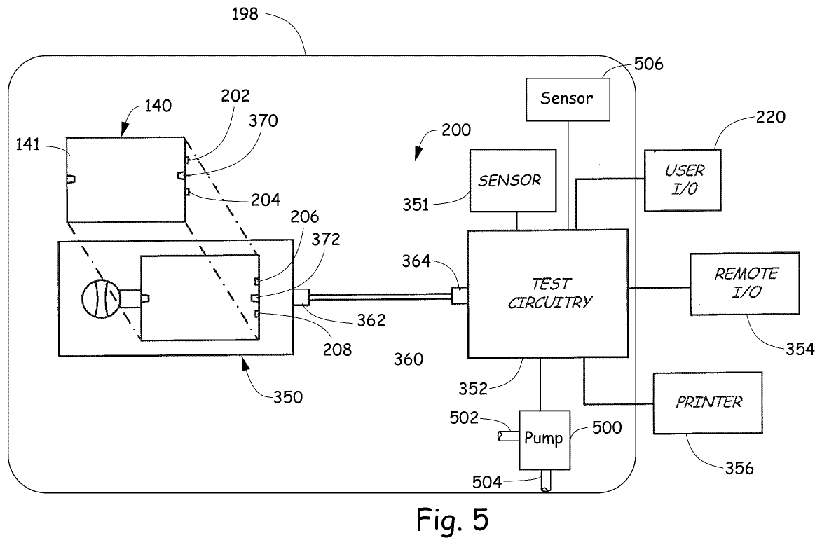

FIG. 5 is a simplified block diagram of vessel 198 showing battery tester 200 including a battery cradle 350. Tester 200 includes test circuitry 352 coupled to user I/O 220. FIG. 7 also illustrates a remote I/O connection 354 for communicating with a remote location such as over a network, to a centralized data system, to other electrical equipment, to a remote user, etc. An optional printer 356 is also illustrated in FIG. 5 and can be used to provide a physical hard copy of test results or other information.

The test circuitry 352 couples to the cradle 350 through cable 360. Cable 360 has ends 362 and 364 which plug into the battery cradle 350 and the test circuitry 352, respectively. The battery 140 can be placed into the cradle 350 whereby tests may be performed on the battery 140. Battery 140 is illustrated as including battery terminals 202 and 204 which couple to Kelvin connections 206 and 208 in cradle 350. These may be Kelvin connections or single connections. A midpoint connector 370 is also illustrated which allows a midpoint test connector 372 to connect to one or more connections between cells or groups of cells within the battery 140. The cradle 350 may also be configured to accept an entire battery pack 104.

The configuration shown in FIG. 5 simplifies the technical requirements of connecting a battery to the battery test circuitry. The use of an individual cradle allows the battery to simply be “snapped” into place for maintenance and transportation. Further, the cradle 350 is configured to provide typical stability to the battery 140 and secure the battery 140 in storage vessel 198 during transportation. Additionally, the cradle 350 can include shock absorbing material and other shock absorbing configuration in which shocks experienced during transportation are reduced. The cradle can include a protective case cover and integrated safety lock to protect the operator and circuitry during testing. Mechanical and/or electrical polarity detection can be used as discussed below in greater detail. The cable 360 can be replaceable as if it becomes worn through extended use. Additionally, different types of cradles can be used for different types of batteries 140 and simply plugged into the cable 360. Some particular types of cradles 350 may use different types of cabling connections 360. This allows the particular cable to be easily exchanged and/or plugged into a different type of cradle 350. In one configuration, the cable 360 represents a wireless communication link such as an RF link using Bluetooth®, WIFI, etc. In such a configuration, part of the test circuitry maybe located within the cradle 350 in order to sense voltages directed and/or apply forcing functions. The remote I/O 354 can then communicate as appropriate including wireless or wired connections such as Ethernet, WIFI, etc. The battery test circuitry 352 can be configured for testing, discharging and charging the battery 140. Some tests or battery maintenance may require discharging or recharging as well as testing the battery 140. FIG. 5 also illustrates an optional sensor 351. Sensor 351 may be a single sensor or a plurality of sensors located either internally and/or externally with respect to the storage vessel 198. Example sensors include temperature sensors, gas sensors, motion sensors, geo positioning sensors or location sensors, shock sensors, altitude sensors, moisture sensors, optional sensors, acoustic sensors, pressure or weight sensors. The measurements obtained by sensor 351 can be used in the battery test, for example adjusting various test parameters, etc. Additionally, the sensor output information can be stored in memory 220, database 222 so it is logged for future reference and/or transmitted to a remote location. This can also be used to determine if a storage battery has been exposed to an improper environment during transportation which may have caused damage to the storage battery. These are examples of environmental sensors and the sensed environment may be an environment internal to the storage vessel 198 and/or external to the storage vessel 198.

In some configurations, the cradle 350 can be configured to accept multiple types of individual batteries 140 or battery packs 104. This allows a single storage vessel 198 to be used with multiple different types of batteries and battery packs. In another configuration, the cradle 350 is removeable from the storage vessel 198 whereby a cradle 350 can be selected for a specific or unique type of battery 140 or battery pack 102. This allows the same battery storage vessel 198 to be used with a wide array of different types of batteries and battery packs.

In one configuration, the state of charge of the battery may be determined using an approximate relationship between voltage of the battery, and/or current in/out of the battery, and state of charge. Other techniques may be used including measurement of dynamic parameter as discussed above. When charging a battery, the battery can be charged using a constant current or constant voltage mode as desired. In such embodiments, the forcing function 210 is configured as a constant or variable current source, a constant or variable voltage source, as well as a load including a constant or variable current load.

Preferably, the test circuitry includes a fail-safe configuration whereby if a voltage of a battery is out of a predetermined range, such as 2.5 volts to 4.25 volts, the current or voltage applied to the battery 140 may be terminated. A power on self-test (POST) and/or watchdog timer can be selectively provided within test circuitry 252 in order to improve the reliability of the device. In one configuration, a “start” button is provided on the user I/O 220 which can be used to initiate a maintenance cycle. Over voltage, current and temperature protection is preferably provided in order to protect the battery and the maintenance circuitry.

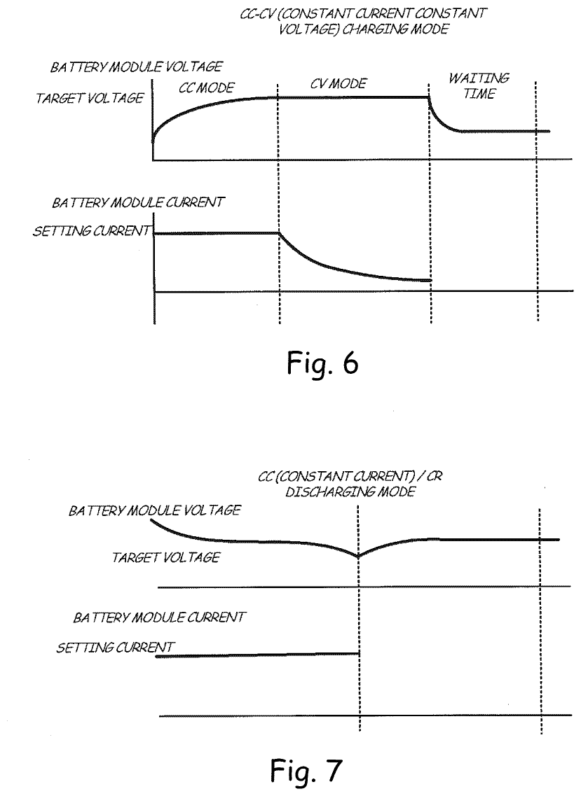

FIG. 6 shows graphs of battery voltage and battery current during a constant voltage charging mode. As illustrated in FIG. 7, during a first phase of operation, a constant current is applied to the battery. In a second period, a constant voltage is applied to the battery followed by a waiting time. These periods can be cycled in order to maximize battery charge. Similarly, FIG. 7 shows a constant current discharging mode. In such a configuration a constant is applied to the battery for a first period of time. The discharge current is then brought to zero amps.

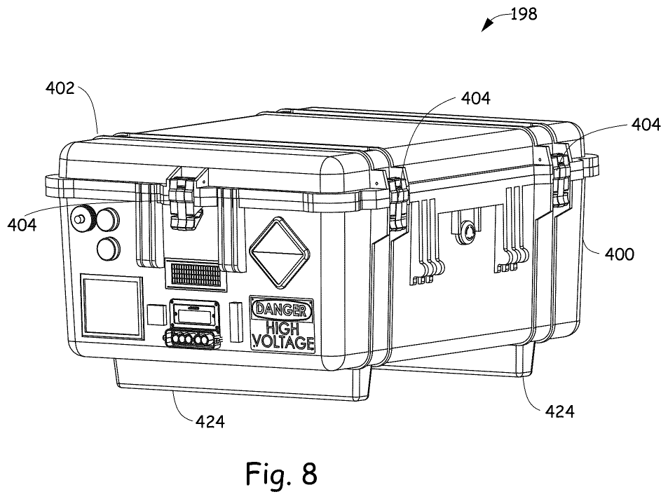

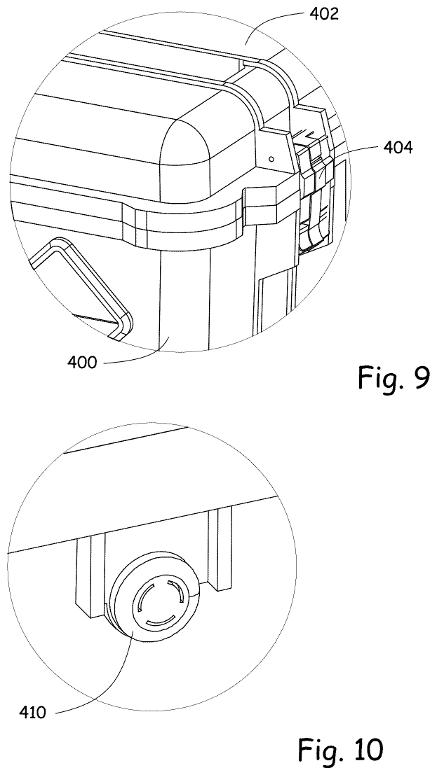

FIG. 8 is a perspective view of electric vehicle battery storage vessel 198. FIGS. 8-28 illustrate specific examples of various aspects of the present invention. As illustrated in FIG. 8, vessel 198 includes a lower or first housing portion 400 which is configured to receive the storage battery of electrical vehicle along with an upper or second housing portion 200. In the specific illustrated configuration, housing portions 400 and 402 are secured together using releasable latches. An optional hinge may also be used between the two housing portions 400 and 402. The latch 404 is more clearly illustrated in FIG. 9. As illustrated in FIG. 10, an optional outgassing vent 410 may be provided on one of the housing portions to allow for the escape of gas from within the sealed vessel 198. For example, a battery may experience outgassing resulting in significant pressure build up within the vessel 198.

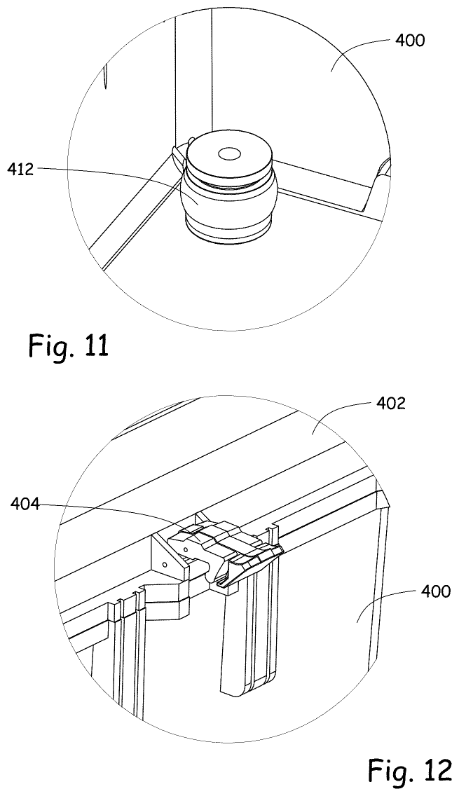

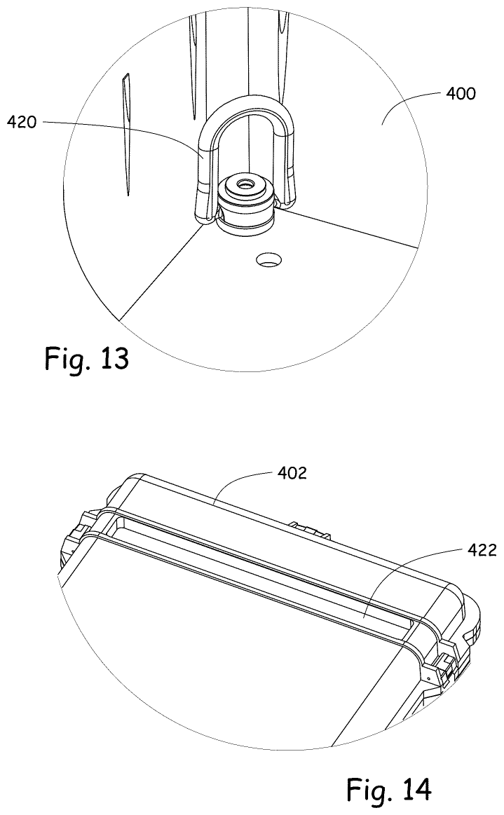

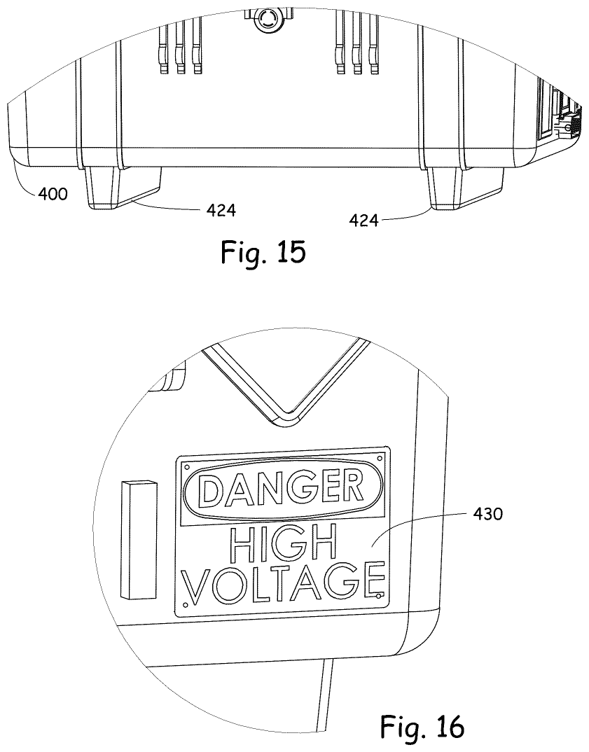

FIG. 11 is a view of an interior of portion 400 configured to receive the storage battery or battery cradle. A shock absorbing footing 412 is illustrated which reduces shock and impact vibrations from being transmitted to the stored storage battery. FIG. 12 illustrates latch 404 in a released position allowing separation of portions 400 and 402. FIG. 13 shows an integrated lifting connection 420. The lifting connection 420 can be located on an interior of the vessel 128, for example in portion 400, or can be located on an exterior surface. Portion 402 can include a groove 422 as illustrated in FIG. 14. This groove 422 can be configured to receive feet 424 shown in FIG. 8 and in FIG. 15. The configuration of groove 422 and feet 424 allows the units to be backed and nested together as illustrated in FIG. 20. Optional safety markers 430 as illustrated in FIG. 16 can be included on an exterior surface of vessel 198.

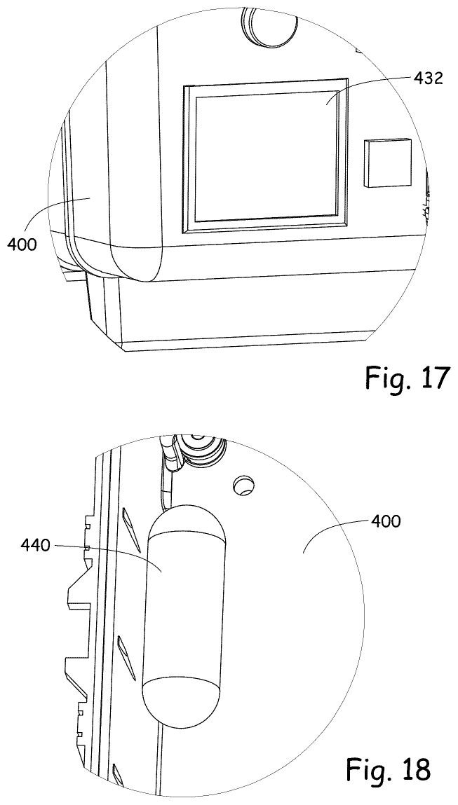

An option documentation pouch is illustrated in FIG. 17. Pouch 432 can be used to carry paperwork associated with a storage battery carried within the electric vehicle battery storage vessel 198.

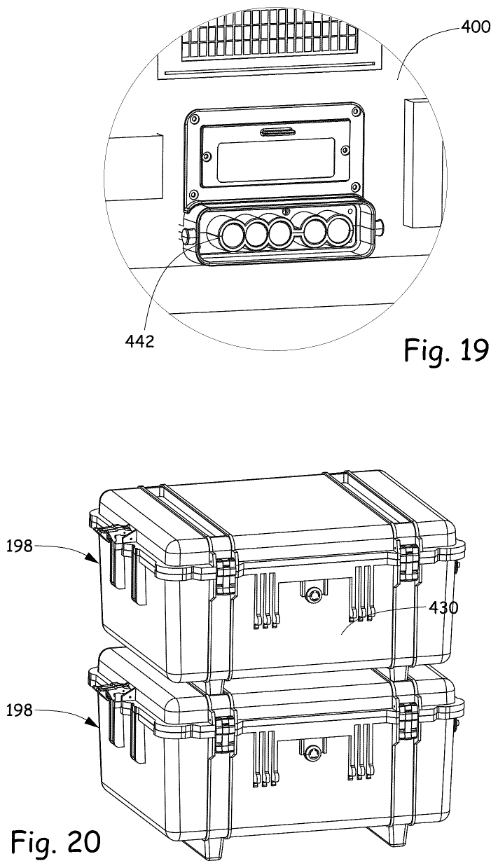

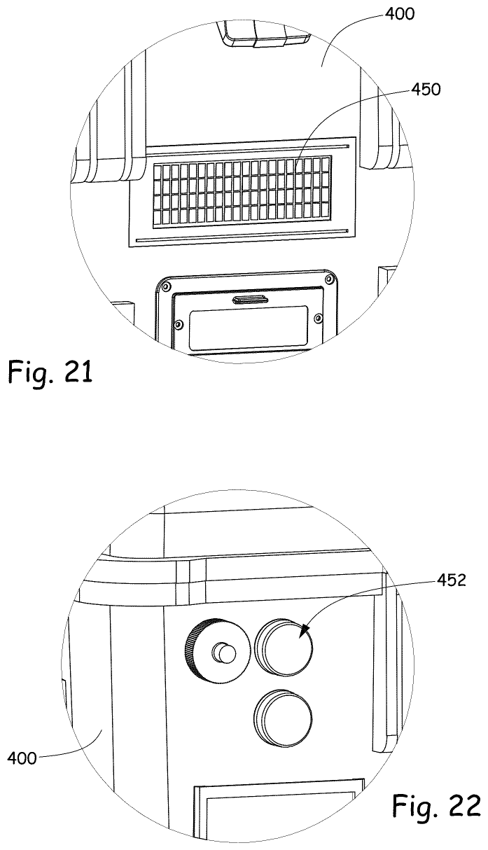

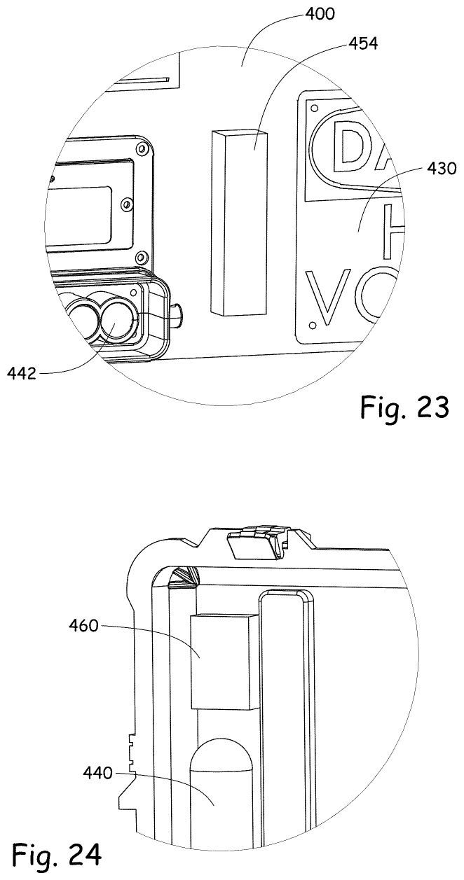

In one aspect, fire suppression equipment is included within the vessel 198. For example, a heat activated fire extinguisher 440 as illustrated in FIG. 18 can be placed in portion 400 of vessel 198. Additionally, the fire suppressing device can be activated manually. The device 440 can be triggered by the temperature within the vessel 198 exceeding a temperature threshold. Further, an electrical plug 442 can be provided which includes electrical connections which extend from an exterior of vessel 198 to an interior of vessel 198 as illustrated in FIG. 19. This can be used to provide connections to battery 140 for charging or discharging. In another configuration this provides connections to, for example, test circuitry 352 shown in FIG. 5. For example, for user I/O 220, remote I/O 354, printer 356, etc. A display 450 can also be provided on an exterior surface of vessel 198 as shown in FIG. 21. For example, this can be user I/O 220 illustrated in FIG. 5. This can display information regarding the vessel 198 itself or battery 140 carried within the vessel 198. This can also be used to provide test results, state of charge information, etc. In one configuration element 450 also includes a user input whereby an operator can control the maintenance of battery 140 for example initiating a test, initiating charging, initiating discharging, etc. A gas sensor 452 as illustrated in FIG. 22 can also be provided to sense the presence of gas due to any outgassing from battery 140. This can activate an alarm or provide some other output to alert an operator as to the condition of the battery 140 within the vessel 198. Another example of a sensor carried on vessel 198 is a shock sensor 454 as illustrated in FIG. 23.

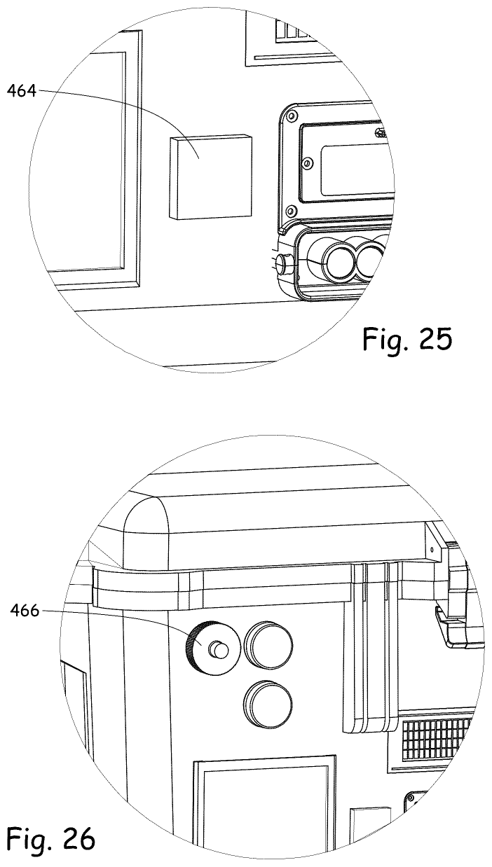

FIG. 24 illustrates a DC to DC converter 460. This can be used to power the battery monitoring electronics from energy contained in the storage battery itself. An optional geotag 464 is shown in FIG. 25 which can record the location of the vessel 198 for example using GPS coordination. This can also be configured to transmit the location information to another location whereby the vessel 198 can be tracked as it transports a battery between locations. Another example of an operator or user output is a warning light or warning alarm 466 illustrated in FIG. 26. This can be activated based upon a test performed on the storage battery, a measurement taken of the ambient environment or environment within the storage vessel 198, or through some other means. This allows an operator to identify a particular storage vessel 198. For example, if an operator wishes to retrieve a particular storage battery, the storage vessel 198 can be contacted remotely to active indicator 466 whereby the operator can identify that vessel 198.

The various concepts and features set forth above can be used to implement the vessel of the present invention.

Features of the enclosed vessel include: fire resistant reusable shell, optionally explosion proof, sealed construction with or without gas release safety vent, shock mounting mechanism for battery pack or component modules, quick release straps or clamps, integral lifting apparatus for battery placement and removal, nested design for stacking enclosures safely, forklift channels integral to the enclosure, standardized safety markings and colors, document pocket for contents specifics, built-in Fire suppression—auto activated or manually activated, connection for charging or discharging while the module or pack is in the enclosure, stackable for easier warehouse or service garage storage, real time wired/wireless connection for alerts or contents status (safety or otherwise) and eternal status indicator for warnings connected to sensor (wired or wireless).

Example sensor features include: low power system for continuous operation powered by primary or secondary cells, gas sensor to detect presence of toxic or explosive gases contained within the vessel, shock sensor to capture potential transportation damage, DC/DC converter to power monitor system from battery or component modules directly, capability to query built in battery or module monitor electronics to read cell, module or pack voltages and temperatures, capability to close battery contactors to read voltage, integral GPS sensor for asset tracking or geo-fencing, serialized enclosure tracking number and can be programmed to check that pack meets all shipping requirements before assigned to container and generating a unique code to verify the pack is safe to ship.

Reporting features include: reporting methods for all sensors, panel display reading out conditions within the enclosure, wireless connections for transmission of conditions to portable readers or cloud connectivity. This includes communication with personal electronic devices, such as cell phones and apps to enable such communication, remote monitoring using app or cloud based solution, warning lights for conditions requiring attention, buzzer for conditions requiring attention, green light to indicate safe to transport, indication of safe for air shipment (SOC below 30%), green light to indicate OK to store, readout of battery voltage or state of charge, readout of internal temperature, flip sign to show current status of enclosed battery similar to type used on freight trailers, tailored to appropriate battery messages and ability to tie serial number from transport container to batter serial number and create unique shipping code.

Maintenance features include: capability to discharge within the enclosure, capability to discharge with connected external equipment, capability to recharge within the enclosure, capability to recharge with connected external equipment and ability to set contactors to open positions, capability to detect leaks in a housing of a battery pack.

Electric vehicles contain multiple cells in a battery pack, resulting in lethal voltages. The cells are enclosed in a battery enclosure to keep the elements (dirt, water, contamination, etc.) from contacting the high voltages and electrical components of the battery pack. For example, when driving through standing water, water must be prevented from entering the battery pack enclosure and causing electrical shorts. In general, it is important for the battery pack enclosure to maintain its seal to protect the cells from contamination. Typically, battery packs are sealed against the elements, using O-rings, applied sealant or other means.

When the battery in a vehicle is involved in an accident, mechanical damage can occur that can rupture the protective shell of the battery pack enclosure. Additionally, when any service of the battery pack is performed which requires the pack to be opened, it is necessary to check the integrity of the finished battery pack assembly to ensure that a proper seal has been restored. Further, the seal of the battery pack enclosure may degrade over time due to material degradation, exposure to extended mechanical stress, or due to other means. It is therefore desirable to be able to check the integrity of the seal of the container which carries the battery back.

There are a number of solutions currently used to verify this seal. In one example, the pressure of the inside of the battery is raised using compressed air or similar inert gas. The internal pressure of the battery container is then monitored. If the rate at which the internal pressure decays exceeds a specified maximum decay rate, a determination can be made that the seal has failed.

In another example, a visible or otherwise detectable gas is injected into the battery casing, similar to what is used to detect EVAP (Evaporative Emission Control System) leaks in fuel systems. A pressure decay can also be measured. This allows the technician to observe or otherwise detect the presence of any gas leaking from the battery casing. This allows the technician to thereby pinpoint the location of the leak and repair the leaking seal. An example of detectable gases are trace gases that can be detected by a sensor. The sensor can be positioned at various locations around the casing to identify the location of the leak.

These techniques are useful for detecting leaks of gas leaving the battery casing. However, these techniques will not detect a failing seal which only allows gas to enter the battery casing. For example, a seal failure such as a cut, etc. that would seal from pressure inside the battery, but allow elements to enter into the battery casing. This type of a seal failure operates in a manner similar to a check valve. Thus, with the pressurization type test, a battery casing could be determined to be good in that the seal prevents gas from leaving the battery pack enclosure, the seal may still have a failure which would allow water or other material to enter the battery casing.

The invention addresses this problem by reversing the procedure. Rather than applying a pressure to the interior of the battery casing, a differential pressure is applied such that the pressure inside the battery casing is less than a pressure outside of the battery pack casing. For example, a vacuum can be applied to the interior of the battery casing. The internal pressure can then be monitored. If the internal vacuum decays at a rate which is outside of specifications, a determination can be made that there is a seal failure. If the vacuum decays rapidly, a soapy solution or other means can be used to trace the source of the leak on the external surface of the battery pack enclosure. The location of the leak can be identified by observing bubbles and repaired or the enclosure replaced.

In another example configuration, a differential pressure is created by applying a low pressure or vacuum to the outside of the battery pack casing. For example, the battery pack can be placed in the battery vessel 198 discussed herein. The vessel 198 should be sealed and a pressure applied. If the applied pressure decays, a determination can be made that gas is leaking into the battery casing.

FIGS. 3 and 5 illustrate a pump 500 configured to apply a differential pressure to an enclosure 141 of a battery back 104 and/or battery 140 contained in vessel 198. In this configuration, vessel 198 is a leak test vessel and provides an airtight sealed container for the battery or battery pack. The applied differential pressure is such that the pressure applied to the interior of enclosure 141 is greater than a pressure applied to an exterior of enclosure 141. Pump 504 is illustrated as having conduits 502 and 504 which can operate as inlets or outlets. In one configuration, conduit 502 is configured as an inlet and coupled to the interior of enclosure 141 while enclosure 141 is sealed. A pressure sensor 506 is also coupled to the interior of enclosure 141 to measure the interior pressure. Pump 500 is operated by test circuitry 352 to cause a vacuum to form within enclosure 141. Once pump 500 is turned off or otherwise disconnected from the interior of enclosure 141, pressure sensor 506 can be used to determine if the enclosure 141 leaks causing the vacuum, or low pressure, in enclosure 141 to decay. In another example configuration, vessel 198 is sealed and pressure sensor 506 monitors the pressure within vessel 198. After a vacuum or otherwise low pressure is applied to the interior of enclosure 141, if the pressure measured by pressure sensor 506 decreases, it is an indication that gas/air from within vessel 198 is leaking into the interior of enclosure 141. In either case, test circuitry can provide an output, for example through user I/O 220, indicating that enclosure 141 has a leak.

In another configuration, conduit 502 operates as an outlet to increase the pressure within vessel 198 using pump 500. In this configuration, once the pressure in vessel 198 has reached a desired level, operation of the pump 500 can be stopped. If the pressure measured within vessel 198 decays from this level, a leak in enclosure 141 can be detected by test circuitry 352. In another example configuration, conduit 502 can be configured as an inlet and a low pressure or vacuum can be applied to the interior of vessel 198. Sensor 506 can be used by test circuitry to sense the pressure within vessel 198. The low pressure or vacuum is observed to decay, it can indicate that gas from within enclosure 141 is leaking out of enclosure 141 and into the interior of vessel 198. In either case, test circuitry 352 can provide an output, for example through user I/O 220 indicating that there is a leak in enclosure 141.

The seal testing discussed herein can be performed on an entire battery pack, a partial battery pack, or individual batteries from a battery pack. The seal testing can be performed in conjunction with other testing, including testing of electrical parameters such as battery state of health, batter state of charge, etc. The seal testing can also be performed independently. Typically, air can be used for seal testing. However, any type of gas can be used as desired. A colored gas can be used to assist in identifying a leak in a seal. Although a pump is needed to remove gas from an enclosure or create a vacuum in an enclosure, a source of pressurized gas can be used to increase a pressure within an enclosure. In such a configuration, element 500 can be a source of pressurized gas. Operation of the pump/gas source 500 can be under manual control or performed by test circuitry 352 during an automated testing sequence.

The pump or gas pressure source provides a source of a differential pressure. When controlling the pressure within the battery casing, a sealed connection to the interior of the battery casing must be used. This can be through a fitted connection or some other means. The pressure sensor can comprise a pressure sensor of the battery itself, and the test equipment communicates with the pressure sensor. Further, more than one pressure sensor can be used. The leak testing can be combined with other tests to provide a comprehensive examination of the battery. In one configuration, the test vessel provides an airtight sealed container. In another configuration, the leak test is performed without sealing the battery in a container and a pressure is applied to the interior of the battery.

Although the present invention has been described with reference to preferred embodiments, workers skilled in the art will recognize that changes may be made in form and detail without departing from the spirit and scope of the invention. The pump can operate as a pressurizing pump causing a pressure to increase and/or as a vacuum pump. In addition to air or other gasses, a colored gas can be used so that a leak is visible by observing leakage of the colored gas.

What is claimed is:

1. An electric vehicle battery test vessel, comprising:
a first housing portion configured to securely receive a storage battery of an electric vehicle, wherein the storage battery in contained in a sealed storage battery casing;
a second housing portion arranged to seal the storage battery in the first housing portion, and selectively open whereby the storage battery can be removed from or placed into the first housing portion;
a sealing mechanism configured to seal the first housing portion to the second housing portion;
a differential pressure source arranged to create a pressure differential between an external pressure on an exterior of the storage battery casing and an internal pressure on an interior of the storage battery casing; and
a pressure sensor arranged to measure at least one of the external and internal pressures and monitor for pressure changes indicative of a leak in the storage battery casing.

2. The electric vehicle battery test vessel of claim 1, wherein the external pressure is greater than the internal pressure.

3. The electric vehicle battery test vessel of claim 1 including:
battery monitoring equipment configured to couple to the battery and perform battery maintenance on the battery;
a memory configured to store information related to battery maintenance performed on the battery.

4. The electric vehicle battery test vessel of claim 1, wherein the internal pressure is greater than the external pressure.

5. The electric vehicle battery test vessel of claim 1 wherein the differential pressure source comprises a pump.

6. The electric battery vehicle test vessel of claim 1 wherein the differential pressure source comprises a source of compressed gas.

7. The electric vehicle battery test vessel of claim 1 wherein the differential pressure is created with a gas.

8. The electric vehicle battery test vessel of claim 1 wherein the differential pressure is created with air.

9. The electric vehicle battery test vessel of claim 1 including test circuitry configured to monitor a rate of decay of the differential pressure.

10. The electric vehicle battery test vessel of claim 1 including battery test circuitry configured to perform a battery test on the battery.

11. The electric vehicle battery test vessel of claim 1 wherein the battery comprises a battery pack.

12. The electric vehicle battery test vessel of claim 1 wherein the battery comprises a battery used in a battery pack.

13. The electric vehicle battery test vessel of claim 1 wherein differential pressure couples to the interior of the battery.

14. The electric vehicle battery test vessel of claim 1 wherein differential pressure couples to the exterior of the battery.

15. The electric vehicle battery test vessel of claim 1 wherein the pressure sensor senses a pressure in the interior of the battery.

16. The electric vehicle battery test vessel of claim 1 wherein the pressure sensor senses a pressure of the exterior of the battery.

17. The electric vehicle battery test vessel of claim 1 including a gas sensor to detect toxic or explosive gases contained within the storage vessel.

18. The electric vehicle battery test vessel of claim 1 wherein the differential pressure source comprises a vacuum pump.

19. The electric vehicle battery test vessel of claim 1 wherein the differential pressure source applies a colored gas.
